(19) United States
(12) Patent Application Publication
(10) Pub. No.: US 2015/0104549 A1
(43) Pub. Date: Apr. 16, 2015

(54) PROCESS FOR DEEP THERMAL TREATMENT OF CORN, FOR HIGH-YIELD PRODUCTION OF WHOLE NIXTAMAL (BOILED CORN) AND REACTOR FOR OBTAINING THE NECESSARY CONDITIONS FOR THE PROCESS

(71) Applicants: Roberto Leopoldo CASTRO GENERA, Irapuato (MX); Olga Alicia LOBO IRUEGAS, Irapuato (MX)

(72) Inventors: Roberto Leopoldo CASTRO GENERA, Irapuato (MX); Olga Alicia LOBO IRUEGAS, Irapuato (MX)

(21) Appl. No.: 14/512,620

(22) Filed: Oct. 13, 2014

(30) Foreign Application Priority Data
Oct. 14, 2013 (MX) MX/A/2013/011960

(51) Int. Cl. B02B 1/04; A23L 1/10

(52) U.S. Cl. CPC B02B 1/04; A23L 1/1033; A23V 2002/00
USPC 426/231; 426/626; 99/348; 99/325

(57) ABSTRACT

The present invention refers to a new, different cooking process of products to be nixtamalized, for instance, corn, as well as a specially designed reactor to be used in the deep thermal treatment. Essentially, the process comprises the loading of a mixture of product to be nixtamalized and water into the container; shaking of the mixture by air injection from an air compressor; separation of floating residues and discharge of wastewater; introduction of hot and clean water into the container and the addition of lime, thus creating a product-water-lime mixture; stirring of the product-water-lime mixture by injecting air from the air compressor; igniting the burner until a target temperature is obtained in the reactor container; and turn off the burner and conditioning of moisture inside the reactor container for a determined period of time where prior to the end of the determined period of time it is proceeded to shake the cooked product-water-lime mixture by air injection from the air compressor.

### FIELD OF THE INVENTION

This document describes a corn treatment process for high-yield production of whole nixtamal, and particularly refers to the process and the reactor for the process mentioned above.

### BACKGROUND OF THE INVENTION

The current state of art used in tortilla factories for the production of nixtamal is practically the same one applied since the days of the Spanish Conquest, varying only in the tools and fuel used. Essentially, the process consists in placing the corn, with no previous flush, in an open container or tank, to which lime and plenty of water is added to make a mixture. A burner is placed at the bottom of the container or tank, usually of butane gas, which burns until boiling (temperature may vary between 88 and 96 Celsius degrees, depending on the elevation above sea level). The necessary boiling time varies from 60 to 90 minutes, depending on the amount of corn, container or tank capacity and burner efficiency, among other factors.

Then, the mixture is left to rest with the cooking water for a period of 5 to 12 hours. After that period, the boiled mixture is flushed and milled.

Nixtamal produced this way losses most of the corn pericarp. Pericarp is mainly comprised of insoluble vegetable fiber, vitamins, minerals, and antioxidants found in corn grain, and when cooked in the traditional way, those nutrients are dissolved due to excess of lime and are lost when the cooking water is disposed of in the drains. These solids and the excessive lime contaminate the process wastewater, known in rural areas as “nejayote”.

The yield of processed corn as described above, expressed as the ratio of kg of produced tortilla vs kg of used corn varies approximately from 1,300 to approximately 1,450 kg of tortilla per approximately 1,000 kg of corn.

Approximately 80% of traditional tortilla factories, such as small family businesses, work within a production range from 100 to 300 kg of tortillas per day. In order to achieve that amount, they need to produce or obtain from 130 to 400 kilograms of nixtamal on a daily basis. Most of the tortilla supply in Mexico is produced in this type of business as well as from similar businesses using nixtamal flour as raw material.

The economic outcomes of tortilla factories highly depend on the characteristics of the nixtamal used as well as on the quality of tortillas. However, the way of cooking corn hasn't been recognized enough and there is no equipment with new technology that improves the traditional procedure, equipment to help increase profitability and quality of the product and at the same time that such equipment is compact, easy to install and operate and with a quick return on investment.

The current way of processing corn in order to obtain nixtamal is susceptible to be substantial improvement. An example of these improvements can be seen in the Mexican patent application no MX/a/2012/003179 filed on Mar. 14, 2012 by the same applicant, wherein an alternative process for thermal treatment of corn for production of nixtamal is described.

Considering these opportunities for improvement, a new and special equipment has been designed, allowing operation under the required conditions of this new process, under different and controlled conditions to produce a better nixtamal, specially a high-yield whole nixtamal, i.e., a nixtamal from which a better quality tortilla may be obtained, soft, flexible and more resistant, among other advantageous characteristics; all this without the need of additives. In such tortilla all the corn components are preserved with a higher yield of tortillas in order to improve business profitability and the quality of tortilla.

55% of all tortilla factories in Mexico use corn as raw material to produce nixtamal which, when milled, produces the necessary dough to make tortillas. The rest of the tortilla factories use nixtamalized corn flour, an industrial product that, when mixed with water in a mixer, produces the dough to make tortillas.

The transformation rate of Corn/Tortilla with the traditional system depends on the level of control of the tortilla factories, where approximately 1,300 to approximately 1,450 kg of tortilla are made for each 1,000 kg of flour. Tortilla factories that use nixtamalized corn flour operate within a range from approximately 1,800 to approximately 1,900 kg of tortilla for approximately each 1,000 kg of corn flour.

When operating a tortilla factory with high yield whole nixtamal, such as the one produced with the process and the equipment described in the patent application herein, a yield or transformation rate of approximately 1,750 to approximately 1,850 kg out of approximately 1,000 kg of corn is obtained by using corn as raw material.

In the traditional system, the pericarp is dissolved, hydrolyzed, and is separated during the flush, thus practically all of the pericarp is discarded, which constitutes an important loss that affects the producer's profitability and that affects product quality, as well as consumers, since valuable components from the pericarp are lost, such as vegetable fiber, vitamins, minerals, antioxidants and nutraceutical (nutritional and pharmaceuticals) substances, which are natural components of corn.

### SUMMARY OF THE INVENTION

This document introduces a different, new process, as well as the reactor specially designed for this process. The process described is for a deep heat treatment for corn for high yield production of whole nixtamal, however, we must remark that the process may be applied to other products, such as any type of grains, cereal or legume, among others. In order to prevent repetitions, we shall refer hereinafter as “product” to any type of grain, cereal or legume, including but not limited to “corn”.

The procedure starts when product is introduced into the reactor previously filled with water. Product suspended in water is then stirred with compressed air so bad grains, foreign particles, dirt and pesticide residues among other items are eliminated. This process is performed at room temperature. Once corn is clean, water is discharged to an auxiliary tank where it is recycled through a filter, preferably a sand or gravel type filter by means of a pump, until clarified for its subsequent use. Water, from a heater, preferably from a solar heater, heated from approximately 50° C. to approximately 70° C. is then added to the reactor. Hydrated lime or quicklime is also added in a proportion which may vary from one (1) to twenty (20) parts per one thousand parts of product. A metal container with a sample containing a specific weight of the product is introduced into the reactor as a process control element. Heat is added to raise water temperature in the reactor up to an approximate range from 70° C. to approximately 100° C. Once temperature is reached, heat supply is stopped and an idle period from approximately 20 to approximately 50 minute follows, in order to homogenize moisture of internal components of the product. At the end of this idle period heat is back on to increase temperature in the reactor tank up to a level within a range from approximately 100° C. to approximately 130° C. approximately, increasing tank inner pressure to a range from approximately 0.1 to approximately 2.1 kg/cm². When reaching the above targets, heating is off and a constant temperature idle period begins from approximately 5 to approximately 30 minutes. When this second idle period ends, reactor inner pressure is lowered to atmospheric pressure level, thus decreasing inner temperature. The reactor can be opened at this time to take out the corn sample from the metallic container to know its weight. By comparing its weight with the original one, and also considering the required characteristics of the nixtamal, the process may be either considered as complete or nixtamal is kept inside the reactor for an additional period of time before starting the final cooling process. Treated water is used for the cooling phase in order to diminish microbiological content, preferably using UV radiation and adding ozone gas. By using treated water, more hygienic and longer lasting dough and tortillas are obtained without the need of preservation additives.

Therefore, the invention has the purpose of offering a different technology from the traditional one in order to cook by this new way corn, grains, cereals or legumes, among others, in a deep fashion, increasing this way their internal temperature and moisture in such a manner as to obtain a more homogenously internal cooked product, thus producing a higher yield, such as high yield whole nixtamal. Along with this purpose, it is also intended to provide a different final product, better than that obtained in the traditional fashion. By using the method of the present invention corn pericarp can be preserved in the grain and obtaining, by using this cooking technology, top quality, longer lasting, softer and more flexible tortillas without needing the addition of food additives.

Also, derived from the above, there is the purpose of obtaining a higher yield of corn; by using this method yield increases 25 to 30%; in other words, more tortillas from the same amount of corn are obtained. Whereas by using the traditional system an average of 1,400 grams of tortillas is obtained from 1,000 g of corn; this new processing technology allows obtaining a yield within the range from approximately 1,750 to approximately 1,850 grams of tortilla out of the same 1,000 grams of corn.

Thus, another purpose is to practically keep the whole pericarp and to reduce pollution of wastewater since its organic solids content is lesser.

Another purpose is to reduce fuel consumption between 30 to 50% so the combustion emissions, greenhouse effect gases, are reduced in the same rate.

An added purpose is to reduce processing time, specifically total process time is reduced to less than 120 minutes, whereas cooking time in a traditional system lasts from 6 to 14 hours.

This new technology for cooking corn and other grains, satisfactorily solves the problems with the current technique in tortilla factories that use corn as raw material, problems that affect productivity, quality of tortillas, combustion gas emissions and contaminated water discharges. Therefore, another goal of this technology is to improve the environmental conditions and contribute with the following:
To significantly reduce the time needed to cook corn for obtaining nixtamal.
To prevent from losing an important vegetable fiber, vitamins, minerals, antioxidants and nutraceutical substances that are part of the grain, which means a loss that affects production costs and diminishes nutrition properties of tortilla.
To significantly reduce polluted wastewater flow and contents of organic solids.
To reduce production costs by decreasing fuel consumption required for cooking, savings from 30% to 40% of fuel consumption necessary to cook corn.

An important positive consequence of the reduction in fuel consumption is the decrease, at the same rate, of the emission of combustion gases, especially CO₂, gases that cause greenhouse effect in the atmosphere, which contributes in increasing environmental temperature, a cause of changes in weather patterns.

Another important advantage is that tortillas made using high yield whole nixtamal, or the end product after cooking, is to obtain better nutritious characteristics since practically all the components from pericarp are preserved, such as: insoluble vegetable fiber or dietary fiber, vitamins, minerals, antioxidants, nutraceutical substances (substances that contribute with nutritional and pharmaceutical benefits), and elements that are a part of the corn grain, among others. In the traditional process, the components above are mostly lost since those are diluted in the cooking water and are discarded in the drains. Also, by using this new system, tortilla obtained is better digested and absorbed due to its additional fiber content and a better gelatinization of corn starches, tortilla advantages that can only be obtained from the deep cooking process, at higher pressure and temperature; work conditions that are not found in the traditional process technique.

By increasing content of vegetable fiber or dietary fiber as well as the fiber formed by cellulose and hemicellulose that can not be digested by the gastrointestinal system, a satiety sensation is produced, thus decreasing appetite and reaching satisfaction with a lesser ingestion of food. Additionally, this kind of fiber stimulates the intestinal tract and improves bowel movement.

These advantages shall benefit millions of consumers since tortilla is the base of Mexico's staple diet.

Annual consumptions per capita are reported in Mexican surveys in the level of 120 kilograms, which means 328 grams daily, equivalent to approximately 12 tortillas daily.

The results shown in this document have been obtained in the field and at a normal tortilla factory scale, since in addition to the designing and building of this special cooking system for cooking corn for the production of high yield whole nixtamal, which is the purpose of this application, a commercial stone mill was also installed to mill nixtamal and produce dough, along with a commercial tortilla machine in order to produce tortillas. Therefore we have a pilot installation capable of producing the new high yield whole nixtamal and to transform it into dough to elaborate 3,000 tortillas per hour, of better quality than the standard tortilla. This installation has been operating on a daily basis during several weeks with the results shown herein.

### BRIEF DESCRIPTION OF THE FIGURES

The particular characteristics and invention advantages, as well as other objectives of the invention will be shown in the following description, related to the attached figures, which:

FIG. 1 shows a flow diagram of the process for the thermal treatment of a product.

FIG. 2 shows a process equipment layout drawing.

FIG. 3 shows in detail the reactor cross section.

### DETAILED DESCRIPTION OF THE INVENTION

The characteristic details of this new system for processing corn and other grains, cereals or legumes, will be given in the following description. For future reference, the term “product” should be understood as corn and other grains, cereals and/or legumes that are subject to the process of the present invention, by means of the reactor of this invention.

The term “approximately” should be also taken as a finite term. The term “approximately” specifically provides an additional determined range defined as an additional range of approximately ±10%. For instance, but not limited to, it is said “approximately 100° C. to approximately 130° C”, the exact range is between 90° C. and 143° C., or between 110° C. to 143° C., or 90° C. to 116° C., or between 110° C. to 116° C. Either of the above possibilities is covered by the term “approximately”.

The system to be described is intermittent or by batches in which the product is processed in different amounts according to the size of the selected reactor and to the amount desired to be processed since loads may be made of a fraction of the rated capacity.

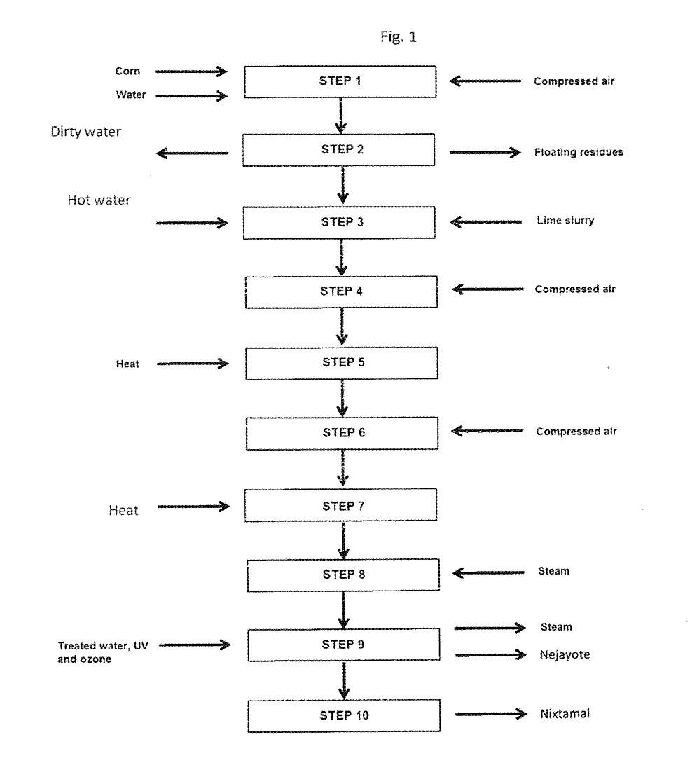

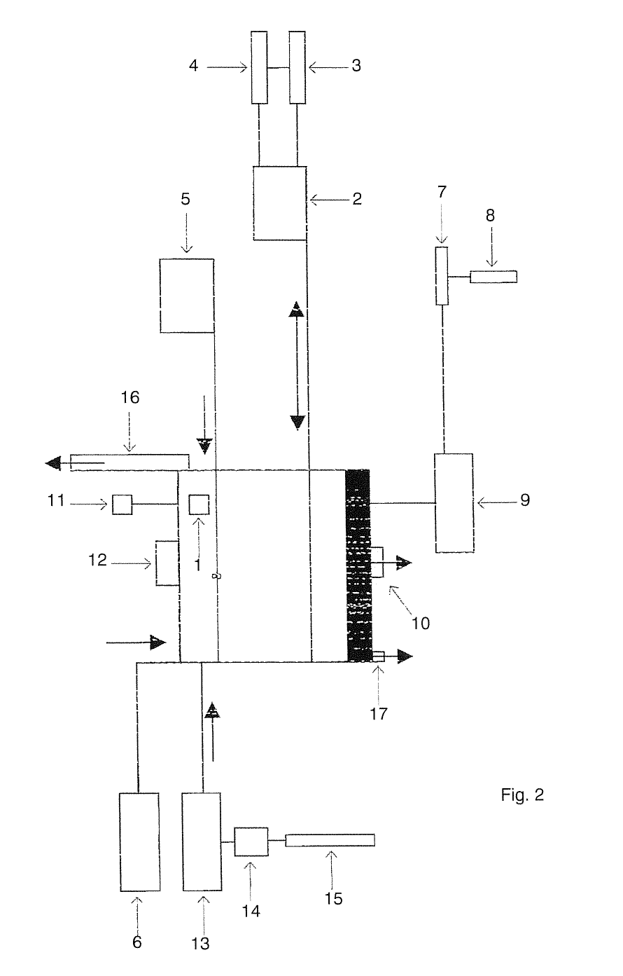

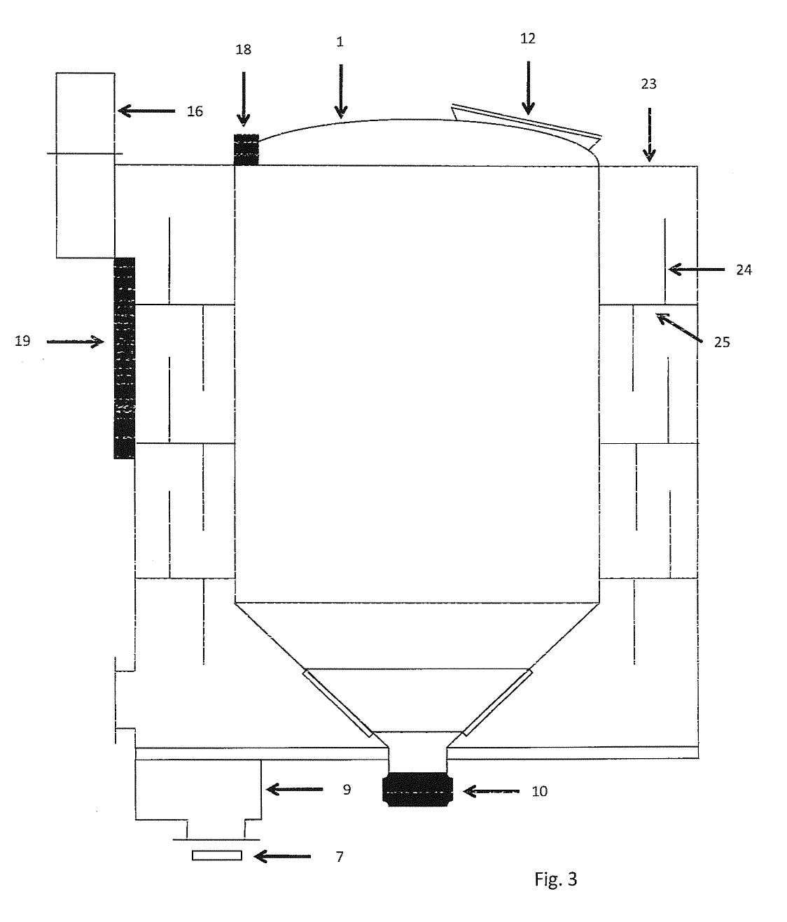

In any case and in all reactor sizes the process to be described and as shown in FIG. 1, shall be the same. The following description makes reference indistinctively to FIGS. 1, 2, and 3.

Container of reactor (1) is loaded with clean water at room temperature. Then the product load to be processed is added. It is preferable that the water-product proportion is within the range of approximately 0.7 to approximately 1.5 parts of water by one part of product, this proportion may vary according to the product to be processed. A container, preferably metallic, containing a sample with a specific weight content of the product is placed into the product. It is desired that the sample has a specific weight content of the product, for instance, one (1) kilogram of the product to be processed. When product and water are inside the reactor container (1), compressed air is applied from the bottom of reactor (1), provided by an air compressor (5) to shake the water-product mixture and to get rid of adhered dust with potentially pesticide residues in the surface of the product, as well as to separate by floatation, foreign particles, bad grains or pieces of corn cobs, among others. Compressed air is injected through at least a metallic pipe; said pipe directs compressed air towards the bottom of the reactor, for product stirring. It is preferred that the pressure of compressed air be in an approximate range from 3 to aproximately 7 kilogram per square centimeter. The approximate time of agitation is between approximately 35 to approximately 120 seconds, preferably from approximately 45 to 90 seconds.

When injection of compressed air is finished, floating material is separated from the reactor container (1) and wastewater is discharged into a recovery tank (2) where it is clarified by a centrifuge pump (3) and a filter (4), preferably a sand or gravel type filter through which wastewater is circulated in order to be clarified to reuse it in the following production batch. An option is to completely discard this water and use clean water in the next production batch.

Subsequently, the access lid (12) located on top of the reactor is closed with quick closing devices, which are fixation devices among which is preferred the one-hand clamps, which facilitate opening and closing the reactor lid in a safe fashion and withstand the thrust of the pressure while keeping the lid in place.

The reactor container (1) is loaded with clean water and heated to a temperature that may vary from approximately 50° C. to approximately 80° C. It is preferred that this heated water be supplied by a solar water heater (6). Lime is then added as slurry, either as slacked lime, calcium hydroxide or quicklime, calcium oxide, in a proportion related to the product, which may vary within the range of approximately 1 to approximately 20 parts per million, depending on the quality of the product and the desired characteristics of the nixtamal to be produced. The lid is closed after adding lime.

After adding lime to the container with the product and hot water, the lid is closed to shake the mixture with compressed air from the air compressor (5) for a time from approximately 35 seconds to approximately 120 seconds, preferably from approximately 45 to approximately 90 seconds, and better still from approximately 50 to approximately 85 seconds approximately, thus stirring the product-water-lime mixture in order to obtain an homogenous mixture of the components. Compressed air is injected through at least one pipe. Compressed air pressure is preferred at a range from approximately 3 to approximately 7 kilograms per square centimeter.

At the end of the agitation period, the main fuel valve is opened and the gas burner (7) is ignited, the gas flow is adjusted by means of a rotameter or flow meter (8). Gas flow is adjusted in order to reach a determined temperature. Combustion gases are injected from the combustion chamber (9) to the reactor, surrounding the reactor container (1). Diverse heat sources may be used, such as water steam generated by an external boiler or solar energy. Steam may be live steam into the pressure tank or by internal steam exchangers. Heat is generated in the combustion chamber, generating combustion gases at a temperature range between approximately 500° C. to 600° C. It is better that the combustion chamber (9) be a metallic container designed to stand inner temperatures of up to 800° C., this temperature is necessary to assure the maximum efficiency of gas combustion. The combustion chamber (9) is thermally insulated in order to prevent heat losses and has a device to control flow of atmospheric air through the combustion chamber. The combustion chamber (9) may be metallic and welded to the external wall of the reactor, specifically to the lower wall and to the bottom of the outer metallic concentric tank (23). The combustion chamber (9) directs the flow of hot gases into a second heat transfer chamber through an annular gap located between the reactor container wall (1) and the external tank (23), gap located and designed with an area to direct gas flow at a certain velocity in order to obtain the maximum heat transfer to the interior of the pressure tank. The reactor has a heat transfer rate to the interior of the pressure tank of approximately 1,800 to 2,200 BTU per hour per kilogram of product to be processed. It is preferred that the velocity be approximately 2 to approximately 7 meters per second. The reactor has three additional heat transfer chambers in the interior of the tank, formed by concentric-ring-shaped directional partitions (25) where such directional partitions may be metallic and welded to the exterior or interior walls of the reactor container (1) and the external tank (23), respectively. Each heat transfer chamber has its annular gap located between the reactor container (1) and the external tank (23) with the purpose of directing gas flow from one heat transfer chamber to the next chamber and up to the gas outlet in the chimney stack.

Burner (7) is kept burning until temperature inside the reactor reaches a temperature which may vary from approximately 60° C. to approximately 100° C.

While burner (7) is ON, combustion gases surround the reactor container (1) and are contained for additional periods of time surrounding the reactor container (1), circulating between the reactor container (1) and an external tank (23) to the reactor container where the external tank has vertical heating blades (24) designed and located to increase heat surface and heat transfer, as well as by directional partitions (25) of combustion gases, which form together with the internal jacket wall and the external wall of the pressure tank, a duct for combustion gases between the combustion chamber and a chimney stack (16) integrated to the reactor, where such chimney stack (16) allows combustion gases to exit the reactor into the atmosphere. The directional partitions (25) and the vertical blades (24) work similarly to the furnace baffles by allowing combustion gases to be directed in specific directions, or that the combustion gases remain for a determined period of time in specific places. This means that the directional partitions (25) have the function to direct the flow of gases while the vertical flaps (24) increase heat transfer to the interior of the reactor tank, and thus, to the mixture of product, reducing the time of process and consequently, improving use of fuel. That is, both the vertical flaps (24) and the directional partitions (25) are capable of both controlling the flow of gases and achieving a high heat transfer inside the reactor container (1) in order to reduce process time and fuel consumption, and structurally reinforcing at the same time the reactor container (1). The external tank (23) is concentric to the reactor container (1) in a jacket fashion, with dimensions designed so along with the directional flaps (25) create a flow of combustion gases in the exterior of the reactor container (1) at such a velocity as to maximize heat transfer to the interior of the reactor container, thus obtaining a minimum process time and high thermal efficiency, resulting in a lower fuel consumption.

Surrounding the external tank, there is a heat insulation medium (19). The heat isolation medium (19) consists preferably of approximately 2.7 to 3.8 thick of ceramic fiber protected by an external stainless steel wall, however, other means of heat isolation may be provided. The heat insulation medium (19) is necessary to reduce heat losses and to optimize thermal efficiency of the reactor.

The chimney stack (16) is necessary to create a natural draft of air induced through the burner (7) and the combustion chamber (9), where the chimney stack (16) is necessary to obtain good combustion efficiency and to move gases through the external tank (23) to their outlet into the atmosphere.

When obtaining the desired temperature, combustion is paused, and the internal moisture conditioning period of the product begins, which may last from approximately 10 to approximately 60 minutes. Before finishing the period of the internal moisture conditioning of the product, the mixture is agitated inside the reactor container (1) by injecting compressed air from the air compressor (5). It is best that this stirring during the conditioning period lasts from 7 to 4 minutes approximately before finishing the conditioning time. Compressed air is, likewise, injected by one pipe at least. It is preferred that the pressure of compressed air is in a range of approximately 3 to approximately 7 kilograms per square centimeter. The approximate time for agitation is from 35 seconds to 120 seconds approximately and more preferably from 45 to 90 seconds approximately.

When finishing the period of conditioning of internal moisture of the product, the burner (7) is lit again, repeating the operations of opening the main fuel valve, igniting the burner (7), adjusting the flow of gas and injecting the combustion gases in such a manner to surround the reactor container (1). However, this time burner (7) is ON until inside temperature of reactor is within a range from approximately 103° C. to approximately 130° C. and/or the inner pressure is within a range from approximately 0.2 kg/cm² to approximately 2.2 kg/cm². When reaching the required temperature, burner (7) is turned off.

Upon reaching the desired temperature in the second heating period, burner (7) is off and the second inner heat and moisture conditioning period begins for a time that may vary from approximately 5 to approximately 50 minutes, depending on the corn being processed and the desired characteristics of the nixtamal.

At the end of the second conditioning period, the steam valve (11) is opened in order to reduce inner pressure of the reactor container (1). Once inner pressure of reactor container (1) is equal to atmospheric pressure, the access lid (12) is opened and the sample container is pulled out through the access. The sample weight is compared with a desired weight. If sample weight is not equivalent to the desired weight, the inner heat and moisture conditioning period is repeated, at least partially, for a determined time according to the weight of the sample and the desired weight. The partial conditioning period essentially means that the lid (12) is closed again to continue with a determined pressure and heat. Specifically, if sample weight is not equivalent to the desired weight, burners are kept off but heat flow is maintained to the interior of the reactor, where heat flow is caused by the thermal inertia of the reactor. The additional flow of heat may vary from seconds to hours, depending on the specific weight obtained of the sample. On the other hand, if sample weight is equivalent to the desired weight, the process is finished.

At the end of the process, the obtained nixtamal is allowed to cool down; nejayote is discharged through the valve (17) and treated water from tank (13) is added, wherein it is preferred that water treatment be by radiation from UV lamps (14) and added with ozone generated by an ozone generator (15). Treated water reduces the microorganism load and thus obtaining a more hygienic and long lasting product. This treated water is used as cooling water. Simultaneously, nixtamal is agitated with compressed air by the air compressor (5). Air injection is done by at least one pipe. It is better to use a pressure of compressed air within a range from approximately 3 to approximately 7 kilogram per square centimeter. Approximate stirring time is from 35 to 120 seconds approximately and preferred from 45 seconds to 90 seconds.

When nixtamal reaches the required temperature, drain valve (17) is opened to discharge cooling water. Once the cooling water is drained, the valve (10) is opened to discharge nixtamal through the bottom of the reactor and transport it to the nixtamal mill. When opening the valve (10), the cooked and cooled mixture flows internally through the conic bottom of the reactor and exiting through the valve (10) in order to transport nixtamal to the mill where it will be transformed into dough to produce tortillas.

It is preferred that the reactor container be a metallic cylinder, which may be vertical or horizontal, closed in its top side by the access lid (12), which should be of torospherical or elliptic profile and closed in its opposite side to the access lid (12) by a cone designed in such a fashion to ease discharge of nixtamal and process wastewater. These three parts are preferably manufactured of stainless steel or other material capable of standing pressure and temperatures required by the nixtamal fabrication process. Also, it is preferred that these three parts comply with the sanitary specifications of food processing equipment.

Access lid (12) to reach the interior of reactor container (1) is equipped with quick activation devices to open and close the reactor container (1) access, as explained above. Access lid (12) has a special seal to withstand such temperatures and prevent pressure leaks.

It is preferred that the reactor have a manifold (18) that, connected to the top of the reactor and with aid of several instruments, allow monitoring inner pressure and temperature of the reactor container (1), and also permitting the safety automatic discharge of steam and manual discharge of steam. It is possible that the manifold is connected to instruments such as pressure gage, thermometer, safety valve for automatic discharge of steam, manual discharge valve of steam, among others.

The reactor may use as a full or complementary source of thermal energy, resistors located in the external chambers of the pressure tank or in the inside of the pressure tank.

Alterations to the structure described herein could be foreseen for those with knowledge in the field of the invention. However, it should be cleared that the description herein is related to the preferred modes of the invention, which are only for information purposes and should not be construed as a limitation of the invention. All modifications not arising from the spirit of this invention are included in the body of the annexed claims.

What is claimed is:

1. In a reactor with a container, an air compressor, a gas burner, a combustion chamber, at least two waste valves and a gas exhaust chimney, a process for the production of nixtamal comprising:
Loading the container with a mixture of a product to be nixtamalized and water;
stirring of mixture by air injection from the air compressor;
separation of floating residues and discharge of wastewater;
addition of hot and clean water into the container and addition of lime to create product-water-lime mixture;
stirring of product-water-lime mixture by the injection of air from the air compressor;
ignition of burner until a desired temperature is obtained in the reactor container; and
turning off burner and conditioning of moisture in the reactor container for a determined period of time, where prior to the end of this determined period of time the cooked product-water-lime mixture is agitated by injecting air from air compressor.

2. The process of claim 1 wherein residual water is discharged to a tank and wherein process also comprises residual water recirculation through a sand or gravel filter until residual water is clarified to be reused.

3. The process of claim 1 wherein the process also includes the steps of:
comparison of time elapsed during conditioning of moisture versus target time; and
if both times are the same, stir the cooked product-water-lime mixture by injection of air from the air compressor.

4. The process of claim 1 wherein the process also includes the steps of:
compare if number of cycles equals the target cycles; and
if cycles are not the same, repeating steps of igniting burner until a second target temperature is reached in the reactor container; and
turning off burner and conditioning of moisture for a second time inside the reactor container for a determined time wherein prior to the end of the determined time it is proceeded to stir the cooked product-water-lime mixture by injection of air from the air compressor;
if cycles are the same, open at least one valve to allow steam to escape.

5. The process of claim 4 wherein the product includes a sample in a container with a specific weight of product, wherein the process also includes the step for comparing weight of the cooked product-water-lime mixture sample with a desired weight, and in the event that weights are not the same, to conditioning moisture inside the reactor container for a determined period of time.

6. The process of claim 4 wherein the target temperature is from approximately 60° C. to approximately 100° C., and wherein the second target temperature is approximately 103° C. to 130° C.

7. The process of claim 4 wherein stirring of cooked product-water-lime mixture is done in approximately 7 to 4 minutes before finishing first and second step of conditioning moisture inside the container and wherein the two conditioning periods last approximately 5 to 60 minutes.

8. The process of claim 1 wherein stirring of the product-water-lime mixture lasts for an approximate period of 35 to 120 seconds, preferably from approximately 45 to approximately 90 seconds and even better from approximately 50 to approximately 85 seconds, under pressure by compressed air of approximately 3 to approximately 7 kilograms per square centimeter.

9. The process of claim 1 wherein the process additionally includes:
cooling the cooked product-water-lime mixture with water treated with UV lamps and conditioned with ozone gas, and simultaneously, stirring of the cooked product-water-lime mixture by air injection from the air compressor.

10. A non-continuous operation reactor, designed to work with loads of product to be nixtamalized that comprises:
a container designed to work under a pressure higher than atmospheric pressure and a high temperature, and with a lid for introducing the product to be nixtamalized, lime, and water to form a mixture in such container;
an external tank that surrounds the container;
at least one air compressor connected to the container which introduces compressed air into the container to stir the corn and lime mixture;
a combustion chamber connected to the external tank and to a heat source, necessary to create an interior atmosphere of high temperature;
a chimney stack of sufficient height to create an air flow by natural induction through the reactor and the combustion chamber;
at least two waste valves; and
at least two heat transfer chambers to the interior of the tank, each chamber formed by a directional partition fitted to the exterior and interior walls of the container and external tank, respectively, wherein directional partitions have vertical flaps to improve heat transfer to the interior of the container.

11. The reactor of claim 10 wherein the container is a metallic cylindrical stainless steel container.

12. The reactor of claim 10 wherein the lid comprises quick activation devices in order to close the lid with the necessary force to prevent inner pressure leaks and to prevent heat and steam loss of container.

13. The reactor of claim 10, characterized because the combustion chamber is heat isolated in order to prevent heat loss and have a device to control flow of atmospheric air through it.

14. The reactor of claim 10, characterized because the external tank is heat isolated by ceramic fiber that at the same time is protected by a metallic housing.

15. The reactor of claim 10, characterized because it comprises a manifold located on the top lid and is connected to the interior of the pressure tank in which several measuring and control instruments are installed as necessary for controlling process conditions.

16. The reactor of claim 10, wherein the heat source is a direct supply of live steam to the interior of the pressure tank or by internal steam exchangers.

17. The reactor of claim 10, which may use resistors located in the external chambers of the pressure tank or inside the pressure tank as full or complementary heat source.

18. The reactor of claim 10 wherein the container is a vertical or horizontal cylindrical pressure tank that may be unloaded through the bottom or the top.

19. The reactor of claim 10 wherein the directional partition is a directional concentric ring welded to and exterior or interior wall of the container and the external tank, respectively.
